(19) United States
(12) Patent Application Publication
(10) Pub. No.: US 2006/0229029 A1
(43) Pub. Date: Oct. 12, 2006

(54) Ultra high frequency / very high frequency (UHF/VHF) band enhancement

(75) Inventors: Alan E. Waltho, San Jose, CA (US); Jeffrey Schiffer, Palo Alto, CA (US); Christopher B. Rogers, Beaverton, OR (US)

Correspondence Address: INTEL CORPORATION, P.O. BOX 5326, SANTA CLARA, CA, 95056-5326, US

(73) Assignee: INTEL CORPORATION

(21) Appl. No.: 11/101,743

(22) Filed: Apr. 7, 2005

(51) Int. Cl. H04B 1/38; H04B 1/40

(52) U.S. Cl. 455/73

(57) ABSTRACT

A wireless device that includes a Ultra High Frequency/Very High Frequency (UHF/VHF) based radio to cognitively search for and use vacant channels and multiple MIMO based radios siliconized with the UHF/VHF based radio.

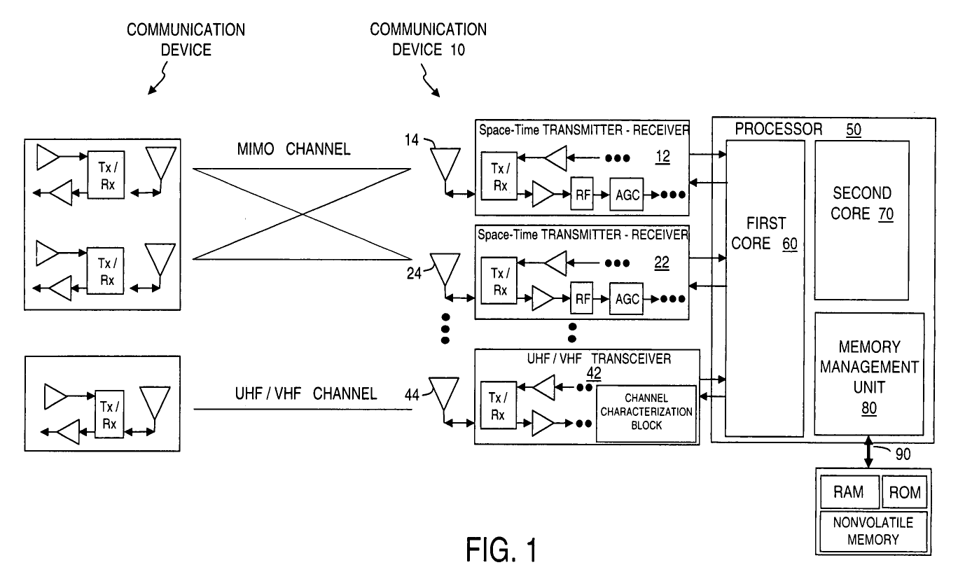

In wireless mobile radio communication, there is a desire for increased capacity and improved quality. Today's portable communication products such as cellular telephones and laptop computers require reception of an accurate data stream at a high data rate for effective operation. It would be advantageous to have a circuit or mechanism for combining the capabilities of two or more radios each operating in accordance with different standards and frequency bands.

### BRIEF DESCRIPTION OF THE DRAWING

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

The sole FIGURE illustrates a wireless device that incorporates circuitry and algorithms to operate a first cognitive radio operating in the UHF/VHF TV frequency band and a second radio operating in a MIMO mode in the 2.4 or 5 GHz ISM frequency bands in accordance with the present invention.

It will be appreciated that for simplicity and clarity of illustration, elements illustrated in the FIGURES have not necessarily been drawn to scale. For example, the dimensions of some of the elements may be exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other while “coupled” may further mean that two or more elements are not in direct contact with each other, but yet still co-operate or interact with each other.

Wireless communications device 10 may be built-in or integrated into a variety of applications such as in laptops, mobile phones, MP3 players, cameras, communicators and Personal Digital Assistants (PDAs), medical or biotech equipment, automotive infotainment products, among other applications. However, it should be understood that the scope of the present invention is not limited to these examples. Communications device 10 may include network connections to send and receive files or other information such as voice, data or video, while handling applications such as Internet access, voice over IP (VoIP), video over IP, e-mail, file sharing and high definition video streaming.

The sole FIGURE illustrates features of the present invention that may be incorporated, for example, into wireless communications device 10. In the wireless communications embodiment, multiple transceivers receive and transmit a modulated signal from multiple antennas. The analog front end transceivers may be a stand-alone Radio Frequency (RF) integrated analog circuit, or alternatively, be embedded with a processor 50 as a mixed-mode integrated circuit. The received modulated signals may be frequency down-converted, filtered, then converted to a baseband, digital signal. The receiver chains may include amplifiers such as, for example, Low Noise Amplifiers (LNAs) and Variable Gain Amplifiers (VGAs) to amplify signals received from the antennas. Mixer circuits receive the modulated signals and down-convert the carrier frequency of the modulated signals.

Processor 50 may include baseband and applications processing functions that utilize one or more processor cores. Processor 50 may use one core to process the digitized quadrature signals, i.e., the in-phase “I” signal and the quadrature “Q” signal from the receiver chain. Cores 60 and 70, in general, process functions that fetch instructions, generate decodes, find operands, and perform appropriate actions, then store results. The use of multiple cores may allow one core to be dedicated to handle application specific functions such as, for example, graphics, modem functions, etc. Alternatively, the multiple cores may allow processing workloads to be shared across the cores. A Memory Management Unit (MMU) 80 includes a hardware/software interface between a host controller software driver and the host controller hardware that exchanges data across memory interface 90 with a system memory. The system memory may include a combination of memories such as a Random Access Memory (RAM), a Read Only Memory (ROM) and a nonvolatile memory, although the type or variety of memories included in the system memory is not a limitation of the present invention.

As shown, communications device 10 includes a radio, allowing communication in an RF/location space with other devices that operate in a wireless network such as, for example, a Wireless Local Area Network (WLAN). In accordance with the present invention, communications device 10 resolves issues of collocation and coexistence of Multiple Input Multiple Output (MIMO) based Wi-Fi (IEEE 802.11n) and Ultra High Frequency/Very High Frequency (UHF/VHF) technologies built into the same platform. Further, communications device 10 is configured to operate across the Industrial, Scientific, and Medical (ISM) bands while providing enhanced ranges, higher data rates and improved performance relative to pure-play, standards based implementations of 802.11x radios.

Communications device 10 employs the Multiple Input Multiple Output (MIMO) many-antenna technique at the transmitter and the receiver side to exploit the spatial dimension and improve the performance of the wireless link. Communications device 10 may include closed-loop or open-loop aerial arrays with multiple antennas at both the transmitter (TX) and the receiver (RX). MIMO forms multiple “virtual channels” that enable higher throughput with improved availability by simultaneously sending the data-stream across each virtual channel at the same time. For each packet that is to be transmitted, the space-time encoder (not shown) chooses the best constellation points to simultaneously transmit from each antenna so that bandwidth, power, and diversity gains may be maximized.

The FIGURE illustrates a first transceiver 12 coupled to an antenna 14 and a second transceiver 22 coupled to an antenna 24 to provide a 2×2 MIMO based radio, although the 2×2 array is not limiting and other arrays such as a 2×3 array, a 2×4 array, among others, may be incorporated. The transmitters in transceivers 12 and 22 may simultaneously transmit parallel data streams over the “virtual channels” from the MIMO antennas 14 and 24. The receivers in the transceivers 12 and 22 detect and separate the superposition of the multiple data streams received by antennas 14 and 24. According to various embodiments, the antenna function may be provided by a substantially omni-directional antenna connected to the receiver, but other embodiments may use a substantially directional antenna.

The FIGURE further illustrates a UHF/VHF transceiver 42 coupled to an antenna 44 to communicate over a channel that is in a UHF/VHF frequency range. The transmitter in transceiver 42 is representative of a television signal transmitter that is transmitting in the UHF/VHF frequency range. Television stations transmit RF signals in the UHF/VHF frequency range (50-806 MHz corresponding to channels 2-69). In one embodiment, UHF/VHF transceiver 42 may operate according to the eight-level Vestigial Sideband (8-VSB) standard. 8-VSB is the standard radio frequency modulation format for the transmission of digital television to consumers chosen by the Advanced Television Systems Committee (ATSC). The 8-VSB standard includes eight amplitude levels that support up to 19.28 Mbps of data in a single 6 MHz channel as specified by the Federal Communications Commission (FCC) for all digital television broadcasting.

Thus, communications device 10 is a combination of Ultra High Frequency/Very High Frequency (UHF/VHF) and Multiple Input Multiple Output (MIMO) based radios that operate in the 2.4 GHz and/or 5.0 GHz ISM frequency bands. These bands offer large available bandwidths and diverse multipath as required for MIMO and high data rate payloads such as High Definition (HD) video streaming applications. The use of MIMO arrays provides an advantage to facilitate coverage within the confines of the home by propagation through obstacles such as buildings and walls at these high microwave frequencies.

In prior art devices, home coverage was obtained by reducing the transmitter data rate that limited or even prohibited high definition video distribution within the home. In accordance with the present invention, the UHF/VHF transceiver in combination with the MIMO array provides the high data rates necessary for high definition video and further provides home coverage. Accordingly, the UHF/VHF transceiver complements the MIMO array to form at least a 2 by 2 plus UHF/VHF array. The UHF/VHF component handled by transceiver 42 carries the streaming high definition video content while the MIMO component handled by transceivers 12 and 22 are reserved for data and other applications. Communications device 10 may employ a modulation method such as, for example, Orthogonal Frequency Division Multiplexing (OFDM), Code Division Multiple Access (CDMA) or Direct-Sequence Spread Spectrum (DSSS).

In operation, the illustrated system operates within an environment where other transmitters are transmitting over wireless channels, such as a number of RF channels in a frequency spectrum. UHF/VHF transceiver 42 operates on a cognitive basis to first identify vacant TV channels. Thus, vacant channels not being used for TV broadcast or by neighboring UHF/VHF transceiver peers that are transmitting at a location in close proximity to UHF/VHF transceiver 42 are identified. An adjacent channel characterization block in transceiver 42 may monitor and characterize the power in adjacent channels, then also determine the power that may be emitted by the cognitive radio.

Thus, wireless communications device 10 has features for evaluating and selecting signals received from multiple antennas in accordance with the present invention. UHF/VHF transceiver 42 may operate on one of the vacant channels, using either a modulation format similar to the native DTV standard or some other suitable modulation method (OFDM, CDMA, DSSS). The cognitive engine may be utilized across both radio bands to optimize the operation of the ISM band MIMO array as well by identifying and thereby avoiding interfering sources that may be present in the ISM bands.

By now it should be apparent that the present invention enhances transmission quality and provides a uniform video performance capability. The use of a UHF/VHF mode minimizes processing complexity, and therefore, cost and power consumption of the radio. In one embodiment, transceiver 12 and transceiver 22 may be siliconized with UHF/VHF transceiver 42 in a single radio device. The present invention enables products to operate over greater ranges and higher data rates and provides measurable performance, power, and cost advantages relative to pure-play standards-based implementations of 802.11n radios.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A communication system, comprising:
a combination of Ultra High Frequency/Very High Frequency (UHF/VHF) and Multiple Input Multiple Output (MIMO) based radios, wherein first and second MIMO based radios have transmitters/receivers coupled to first and second antennas and the UHF/VHF based radio has a transmitter/receiver coupled to a third antenna.

2. The communication system of claim 1 wherein the first and second MIMO based radios and the UHF/VHF based radio are siliconized in a Wireless Local Area Network (WLAN) radio device.

3. The communication system of claim 1 wherein the first and second MIMO based radios have radio links with multiple antennas at the transmitter and the receiver side and the UHF/VHF based radio has a radio link with the third antenna at the transmitter/receiver.

4. The communication system of claim 1 wherein the UHF/VHF based radio is a cognitive radio that searches for and uses vacant channels in the 50 to 800 MHz frequency band.

5. A wireless device, comprising:
a transceiver of the wireless device utilizing Multiple Input Multiple Output (MIMO) based radios with first and second transmitters to couple to first and second antennas and a Ultra High Frequency/Very High Frequency (UHF/VHF) based radio to couple to a third antenna.

6. The wireless device of claim 5 wherein the transceiver is a Wireless Local Area Network (WLAN) transceiver.

7. The wireless device of claim 5 wherein the transceiver uses an Orthogonal Frequency Division Multiplexing (OFDM) modulation technique.

8. The wireless device of claim 5 wherein the transceiver is a Code Division Multiple Access (CDMA) transceiver.

9. The wireless device of claim 5 wherein the transceiver processes Direct-Sequence Spread Spectrum (DSSS) channels.

10. The wireless device of claim 5 wherein the transceiver operates across a license exempt band.

11. The wireless device of claim 5 wherein the first and second transmitters transmit data in a 2.4 GHz to 2.5 GHz range or a 5.150 GHz to 5.825 GHz range and the UHF/VHF based radio transmits in a 50 MHz to 800 MHz range.

12. A multiple-antenna communication system, comprising:
two transmitters that employ Multiple Input Multiple Output (MIMO) to provide radio links to first and second antenna; and
a third transmitter coupled to a third antenna to provide a Ultra High Frequency/Very High Frequency (UHF/VHF) based radio, where the two transmitters and the third transmitter are siliconized.

13. The multiple-antenna communication system of claim 12 further including two receivers to resolve the two data streams from the first and second antenna and a third receiver to resolve a third data stream from the third antenna.

14. The multiple-antenna communication system of claim 12 wherein the two transmitters and the third transmitter, and the two receivers and the third receiver are in a Wireless Local Area Network (WLAN) radio device.

15. A wireless device comprising:
a Ultra High Frequency/Very High Frequency (UHF/VHF) based radio to cognitively search for and use vacant channels; and
first and second MIMO based radios siliconized with the UHF/VHF based radio in the wireless device.

16. The wireless device of claim 15 wherein the UHF/VHF based radio uses vacant channels in the 50 to 800 MHz frequency band.

17. The wireless device of claim 15 further including first and second processing cores in the wireless device.

18. The wireless device of claim 15 wherein the wireless device operates as a Wireless Local Area Network (WLAN) device.

19. The wireless device of claim 15 wherein the UHF/VHF based radio includes a cognitive engine to optimize the operation of the wireless device across radio bands.

20. The wireless device of claim 15 wherein the UHF/VHF based radio receives streaming high definition video.
